(19) United States
(12) Patent Application Publication
(10) Pub. No.: US 2026/0269587 A1
(43) Pub. Date: Sep. 10, 2026

(54) Assembly of Electric Lines Between a DC Power Source and an Electric Drive of a Vehicle

(71) Applicant: BAYERISCHE MOTOREN WERKE AKTIENGESELLSCHAFT, Muenchen (DE)

(72) Inventors: Hauke LITZENBERGER, Muenchen (DE); Mient DE JONG, Eching (DE)

(21) Appl. No.: 19/166,914

(22) PCT Filed: Apr. 30, 2024
(86) PCT No.: PCT/DE2024/100391

§ 371 Date: Sep. 19, 2025

(30) Foreign Application Priority Data
May 31, 2023 (DE) 10 2023 114 277.1

(51) Int. Cl. H02G 3/16; B60L 50/52; B60R 16/02; H01R 24/28

(52) U.S. Cl. CPC H02G 3/16; B60L 50/52; B60R 16/0215; H01R 24/28; H01R 2201/26

(57) ABSTRACT

An assembly of electric lines within a vehicle designed to transmit a direct current between a DC power source and an electric drive of a vehicle, wherein a first end of the electric lines is connected to a first plug unit, via which the electric lines are electrically connected to the DC power source, and a second end of the electric lines is connected to a second plug unit, via which the electric lines are electrically connected to the electric drive. A sub-region of each of the electric lines is produced as an electric line which is more flexible than the rest of the electric line, and the sub-region is positioned in at least one loop.

### BACKGROUND AND SUMMARY This disclosure relates to an assembly of electrical lines that are configured to carry electric current between a DC power source and an electric drive of a vehicle.

Electrically driven vehicles have a power source, which is usually embodied as a rechargeable battery, and an electric drive having an electric machine, which is supplied with electric current via the power source. The power source is generally a DC power source, that is to say provides direct current. This direct current is then converted into an alternating current that can be used for the electric machine. In order to be able to transmit the direct current between the power source and the electric drive, high-voltage direct current cables, DC cables for short, are currently required. These cables must meet various requirements, including electrical requirements, operational safety, mountability and consideration of the available installation space.

Electrical lines (in particular high-voltage and potential-balancing lines) present in cables are often made to be very rigid due to a small available installation space, cross-section and required operational safety, as well as corrosion protection, etc. They are therefore between a dynamically oscillating excitation, for example a drive or gear, and acoustically sensitive and irradiating components, such as the vehicle body as a bridge for structure-borne noise. The structure-borne noise transmitted is measurable and even audible to the passengers in the vehicle.

It is therefore an object of this disclosure to provide an assembly of electrical lines between the power source and the electric drive by way of which less structure-borne noise is transmitted to the vehicle body and thus less noise is perceptible in the interior of the vehicle.

The disclosure proposes an assembly of electrical lines within a vehicle, the electrical lines being configured to transmit direct current between a DC power source and an electric drive of a vehicle, wherein a first end of the electrical lines is connected to a first plug unit, via which the electrical lines are electrically connected to the DC power source, and wherein a second end of the electrical lines is connected to a second plug unit, via which the electrical lines are electrically connected to the electric drive, and wherein a subregion of the electrical lines is formed as an electrical line that is more flexible than the rest of the electrical lines, and wherein the subregion is positioned in at least one loop.

Provision is also made for the subregion to be provided in a central area between the first and second plug units.

Provision is also made for the electrical lines to be disconnected in an area between the plug units in such a way that two respective connection ends are produced, and wherein the subregion that forms the more flexible electrical lines is electrically connected to each end region thereof at a respective connection end of the electrical lines.

Provision is also made for the subregion to be formed as part of the electrical lines and to be non-releasably connected thereto.

Provision is also made for an insulating housing to be provided, in which the subregion is arranged.

Provision is also made for the housing to be formed as a plug unit.

Provision is also made for the subregion of the electrical lines to be provided in an area within the first and/or the second plug unit.

Provision is also made for the electrical lines to be formed as DC cables.

The disclosure also proposes a vehicle, having a DC power source and an electric drive, these being electrically connected to one another via the assembly.

Further features and advantages of the disclosure will emerge from the description of exemplary embodiments of the disclosure that follows, on the basis of the figures of the drawing, which shows details according to the disclosure, and from the claims. The individual features may be implemented in a variant of the disclosure individually in their own right or in groups of two or more, in any desired combination.

Preferred embodiments of the disclosure are explained in more detail below with reference to the accompanying drawing.

### BRIEF DESCRIPTION OF THE DRAWINGS

FIG. 1 shows a schematic illustration of an assembly of electrical lines, which are formed as DC cables, according to the prior art.

FIG. 2 shows a schematic illustration of one embodiment of an assembly of electrical lines, which are formed as DC cables, of the present disclosure.

### DETAILED DESCRIPTION OF THE DRAWINGS

In the descriptions of the figures that follow, identical elements or functions are provided with the same reference signs.

The basic concept of the disclosure is to minimize structure-borne sound that is transmitted to the body 1 and thus as noise into the interior of the vehicle by electrical lines 3, in particular DC lines, which are also referred to as traction lines.

As already mentioned, electrical lines that carry high voltage are installed in the vehicle in order to provide a high-voltage electricity supply for components of the vehicle. In particular, so-called DC cables are used to transmit direct current between the DC power source (rechargeable battery) and the electric drive, as indicated in the figures as an example. The direct current is converted in the electric drive into an alternating current by way of an inverter in order to be provided to the electric machine of the electric drive. The electric machine is used, for example, to drive the wheels of the vehicle. Since direct current always has a negative and a positive line, a DC cable is always formed of two electrical lines 3 with an associated jacket and shield, one of which is used as the positive DC line and the other is used as the negative DC line.

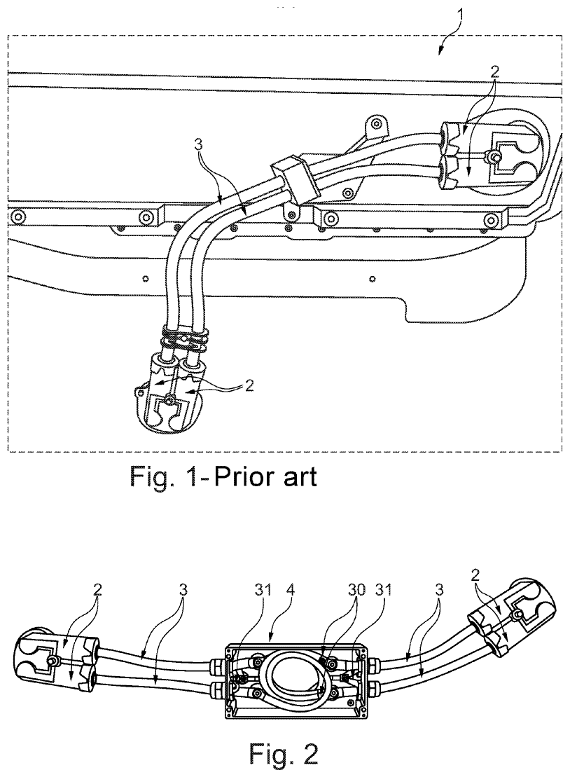

As can be seen in FIG. 1, the electrical lines 3 are led on the shortest path between the DC power source and the electric drive. Both ends of the electrical lines 3 are each connected to a plug unit 2 in order to be electrically connected at one end to the DC power source and at the other end to the electric drive. During operation, that is to say when current is flowing, minimal, invisible vibrations occur within the electrical lines 3. With the present running of the lines, as can be seen in FIG. 1, these vibrations are transmitted to the body 1 as structure-borne sound via the plug unit 2 (at the top of FIG. 1), which is connected to the DC power source, which in turn is fixedly connected to the body 1. As a result, the body 1 begins to vibrate, which is turn is perceptible to the passengers in the interior of the vehicle as noise. In order to minimize the transmission of structure-borne sound, the use of longer electrical lines 3 would be necessary, but this can only be realized with great difficulty due to the available installation space.

It is therefore proposed to form a subregion 30 of the electrical lines 3 as electrical lines that are more flexible than the rest of the electrical lines. 3 As a result, the subregion 30 is bent and thus made to be longer in a smaller installation space. Owing to the electrical lines 3 which are now longer overall, during operation a structure-borne sound formed in the electrical lines 3 is transmitted to the body 1 of the vehicle to a significantly lesser extent or is no longer transmitted at all.

The subregion 30 of the electrical lines 3 is thus longer than the rest of the electrical lines 3 since it is formed of a more flexible material. The cross-section, however, is the same since the current-carrying capacity must be ensured.

The greater flexibility of the subregion 30 means that the subregion 30 (each of the associated lines) can be bent into one or more loops without requiring more space than the rest of the electrical lines 3, as shown by way of example in FIG. 2. In the embodiment shown in FIG. 2, an electrically insulating housing 4 is provided, in which the subregion 30 is arranged. It can be seen that each of the two lines of the subregion 30 is arranged in a loop (or multiple loops). The lines are laid one above the other in this case. Space is thus also saved. The assembly of the lines should of course be such that potentially arising magnetic fields are eliminated as far as possible.

Owing to the insulating housing 4, it is also not necessarily required to shield the lines of the subregion 30 as is required/prescribed for the rest of the electrical lines 3. The shield 31 usually surrounding each of the electrical lines 3 can in this case be led separately inside the housing 4 and combined again at the outputs of the housing 4 with the more rigid electrical lines 3 located outside of the housing 4.

In FIG. 2, the housing 4 is arranged quite centrally between the line ends to which the plug units 2 are attached. This is shown purely as an exemplary assembly since the subregion 30 can be provided between the plug units 2 at essentially any location of the electrical lines 3 depending on the installation space.

The electrically insulating housing 4 shown in FIG. 2 can be formed as a kind of distributor box, as shown. In this embodiment, the electrical lines 3 are divided into two respective partial lines (that is to say four lines), which are connected to one another (releasably) via the subregion 30. The subregion 30 is in this case electrically connected to the other parts of the electrical lines 3 at both connection ends thereof via, for example, cable shoes that are screwed to one another.

In one embodiment (not shown), the housing 4 can also be formed as a plug unit with a plug/socket, by way of which the more rigid electrical lines 3 and the more flexible lines, that is to say the subregion 30, are electrically connected to one another.

In an alternative embodiment, not shown, provision can be made for the (more flexible) subregion 30 to be provided in a plug unit 2, or for two subregions 30 to be provided, each one of which is provided in one of the two plug units 2, which are used for electrical connection to the electric drive or the DC power source. In this case, too, each subregion 30 (each of the lines) is positioned in at least one loop in order to increase the line length.

The subregion 30 is formed of fine stranded wires or wire mesh in such a way that the require flexibility but also the current-carrying capacity can be provided.

In an alternative embodiment, not shown, provision can be made for the more flexible subregion 30 to be manufactured and thus non-releasably connected directly to the more rigid electrical lines 3.

Dividing the electrical lines 3 in such a way that a subregion 30 thereof is made more flexible and thus can be bent in a smaller space means that improved acoustic insulation is provided and less noise caused by structure-borne sound in the electrical lines 3 is transmitted to the interior of the vehicle.

### List of Reference Signs

1 Body
2 Plug unit
3 Electrical lines
30 Subregion of 3
31 Shield
4 Housing

1-9. (canceled)

10. An assembly of electrical lines within a vehicle, the assembly being configured to transmit direct current between a DC power source and an electric drive of a vehicle,
wherein a first end of the electrical lines is connected to a first plug unit, via which the electrical lines are electrically connected to the DC power source, and wherein a second end of the electrical lines is connected to a second plug unit, via which the electrical lines are electrically connected to the electric drive, and
wherein a subregion of the electrical lines is formed as an electrical line that is more flexible than the rest of the electrical lines, and wherein the subregion is positioned in at least one loop.

11. The assembly according to claim 10, wherein the subregion is provided in a central area between the first and second plug units.

12. The assembly according to claim 11, wherein the electrical lines are disconnected in an area between the plug units in such a way that two respective connection ends are produced, and wherein the subregion that forms the more flexible electrical lines is electrically connected to each end region thereof at a respective connection end of the electrical lines.

13. The assembly according to claim 10, wherein the subregion is formed as part of the electrical lines and is non-releasably connected thereto.

14. The assembly according to claim 10, wherein an insulating housing is provided, in which the subregion is arranged.

15. The assembly according to claim 10, wherein the housing is formed as a plug unit.

16. The assembly according to claim 10, wherein the subregion is provided in an area within the first and/or the second plug unit.

17. The assembly according to claim 10, wherein the electrical lines are formed as DC cables.

18. A vehicle, having a DC power source and an electric drive, these being electrically connected to one another via an assembly according to claim 10.
